(19) United States
(12) Patent Application Publication
(10) Pub. No.: US 2015/0030903 A1
(43) Pub. Date: Jan. 29, 2015

(54) PRISMATIC BUSSING METHOD AND DESIGN

(71) Applicant: SAFT, Bagnolet (FR)

(72) Inventors: Matthew Carlton BLOSS, Jacksonville, FL (US); Randy BEDSAUL, Jacksonville, FL (US); Steven Dwaine COCHRAN, Ponte Vedra, FL (US); Björn MARLID, Fleming Island, FL (US)

(73) Assignee: SAFT, Bagnolet (FR)

(21) Appl. No.: 13/950,742

(22) Filed: Jul. 25, 2013

(51) Int. Cl. H01G 11/76; H01G 11/52; H01G 11/84; H01M 2/20; H01G 9/048

(52) U.S. Cl. CPC H01G 11/76; H01M 2/202; H01M 2/204; H01M 2/206; H01G 9/048; H01G 11/84; H01G 11/52
USPC 429/121; 29/25.03; 29/623.1; 361/500

(57) ABSTRACT

An electrochemical cell including a prismatic electrode stack extending in a prismatic plane and having a plurality of positive electrode plates and a plurality of negative electrode plates stacked alternately with intervening separators therebetween. The positive electrode plates and the negative electrode plates are laterally offset so that end leads of the positive electrode plates extend from one side of the electrode stack and end leads of the negative electrode plates extend from an opposite side of the electrode stack. A positive bus strap is joined to the end leads of the positive electrode plates and a negative bus strap is joined to the end leads of the negative electrode plates such that said positive and negative bus straps and attaching portions of said end leads of the positive and negative electrode plates are disposed parallel to each other and perpendicular to the prismatic plane of the prismatic electrode stack. Further, a case may be provided for accommodating the prismatic electrode stack, the bus straps and liquid electrolyte.

### FIELD OF THE INVENTION

The invention relates to an electrochemical cell and more particularly to a prismatic electrochemical cell having an improved bussing design and a method of manufacturing such a cell.

### BACKGROUND OF THE INVENTION

There are two types of prismatic cells: wound prismatic cells and stacked prismatic cells. For each design, end leads (typically made of bare foil) of the positive and negative plates are respectively attached to positive and negative bus straps provided on opposite sides of the prismatic cell with the bus straps being disposed substantially parallel to the plane of the prismatic cells. See U.S. Patent Publication No. 2012/0107668. As a result, the length of the end leads is relatively long. Since these end leads are the inactive portion of the cells, the resulting cell is inefficient, both from a performance perspective and a space perspective.

### SUMMARY OF THE INVENTION

An exemplary embodiment of the invention is directed to an electrochemical cell, comprising: a prismatic electrode stack extending in a prismatic plane and having a plurality of positive electrode plates and a plurality of negative electrode plates stacked alternately with intervening separators therebetween. The positive electrode plates and the negative electrode plates are laterally offset so that end leads of the positive electrode plates extend from one side of the electrode stack and end leads of the negative electrode plates extend from an opposite side of the electrode stack. A positive bus strap is joined to the end leads of the positive electrode plates and a negative bus strap is joined to the end leads of the negative electrode plates such that said positive and negative bus straps and attaching portions of said end leads of the positive and negative electrode plates are disposed parallel to each other and perpendicular to the prismatic plane of the prismatic electrode stack. Further, a case may be provided for accommodating the prismatic electrode stack, the bus straps and liquid electrolyte.

### BRIEF DESCRIPTION OF THE DRAWINGS

FIG. 1 is perspective view of the prismatic electrode stack connected to positive and negative bus straps according to an exemplary embodiment;

FIG. 2 is a partial cross-sectional view of the electrodes and separators for the electrode stack according to an exemplary embodiment;

FIG. 3 is a detailed view showing the connection between the end portion of the positive or negative electrode plate to the associated positive or negative bus strap according to an exemplary embodiment;

FIG. 4 is a perspective view showing a plurality of prismatic electrode stacks connected to the positive and negative bus straps according to an exemplary embodiment; and

FIG. 5 is a perspective view showing the prismatic electrode stacks being inserted into the case according to an exemplary embodiment.

### DETAILED DESCRIPTION OF THE INVENTION

Embodiments will be described below in more detail with reference to the accompanying drawings. The following detailed descriptions are provided to assist the reader in gaining a comprehensive understanding of the methods, apparatuses, and/or systems described herein and equivalent modifications thereof. Accordingly, various changes, modifications, and equivalents of the methods, apparatuses, and/or systems described herein will be apparent to those of ordinary skill in the art. Moreover, descriptions of well-known functions and constructions may be omitted for increased clarity and conciseness.

The terms used in the description are intended to describe embodiments only, and shall by no means be restrictive. Unless clearly used otherwise, expressions in a singular from include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

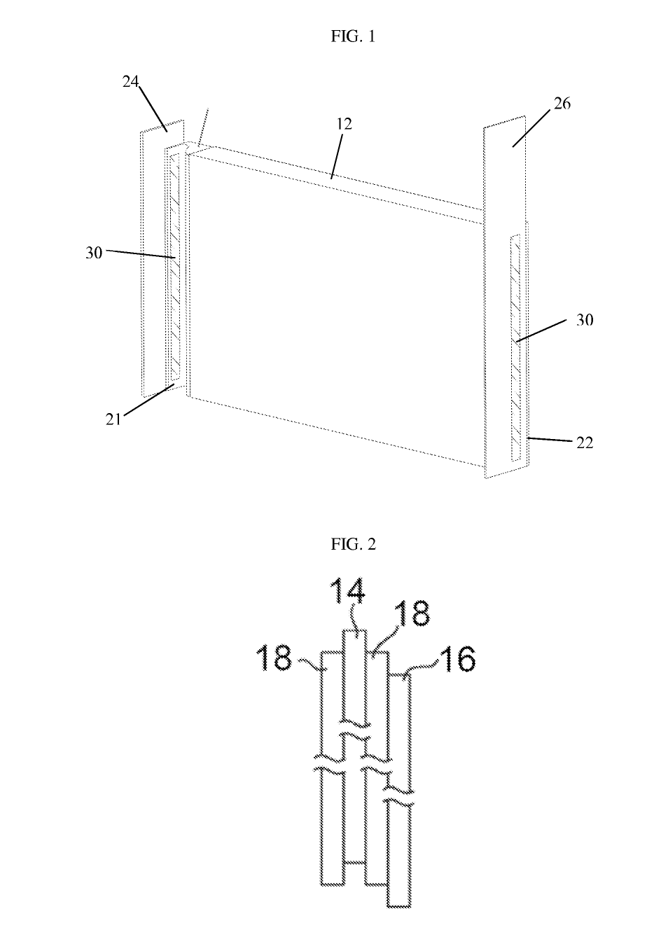

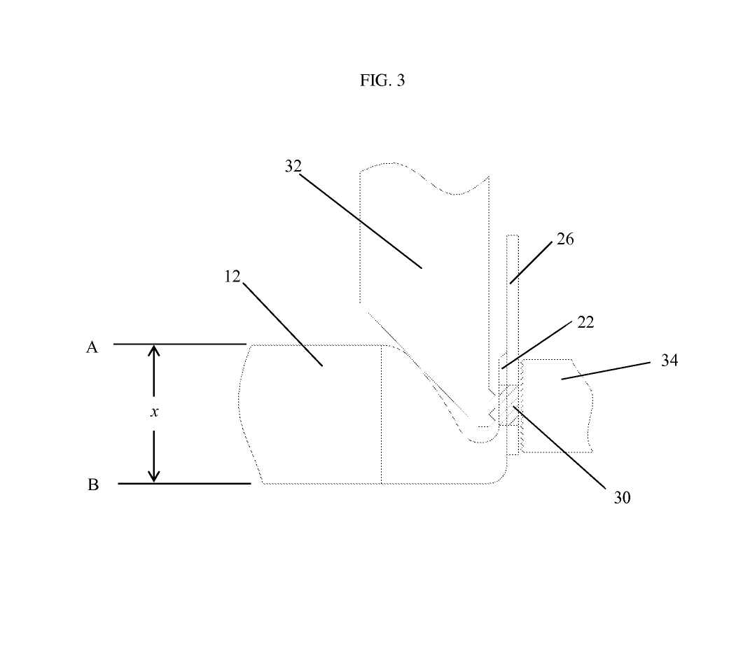

The electrochemical cell 10 according to an embodiment of the invention is illustrated in FIG. 1. The cell 10 includes a prismatic electrode stack 12 extending in a prismatic plane and having a plurality of positive electrode plates 14 and a plurality of negative electrode plates 16 stacked alternately with intervening separators 18 therebetween as shown in FIG. 2. The positive electrode plates 14 and the negative electrode plates 16 are laterally offset so that end leads 20 of the positive electrode plates 14 extend from one side of the electrode stack and end leads 22 of the negative electrode plates 16 extend from an opposite side of the electrode stack.

The end leads 20 of the positive electrode plates 14 are joined to a positive bus strap 24 and the end leads 22 of the negative electrode plates 16 are joined to a negative bus strap 26. That is, according to an exemplary embodiment, the positive and negative bus straps 24, 26 are disposed substantially parallel to each other and perpendicular to the prismatic plane of the prismatic electrode stack 12. In addition, the end leads 20, 22 are arranged such that the connection portions 21 thereof that are joined to the bus straps are parallel to the bus straps to allow them to be joined or welded to the bus straps.

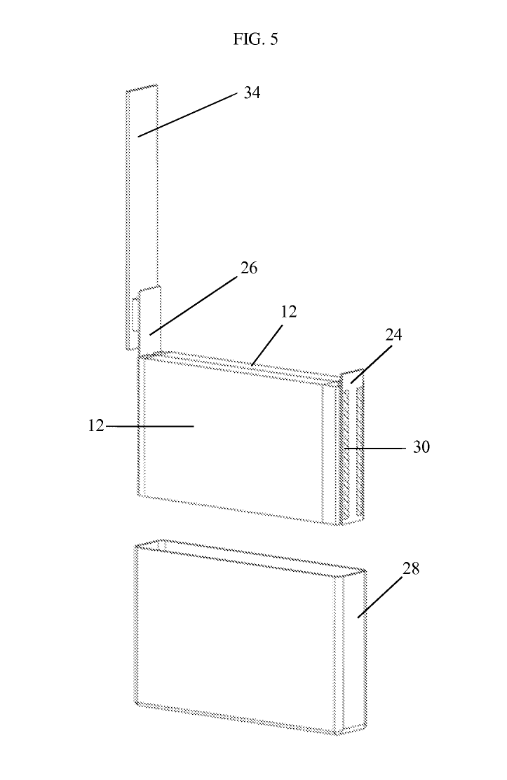

As shown in FIG. 5, a case 28 accommodates the prismatic electrode stack 12, the bus straps 24, 26 and liquid electrolyte.

FIG. 3 is a detailed illustration showing the manner in which the bus straps 24, 26 are joined to the end leads 20, 22 of the respective positive and negative electrode plates 14, 16. Each end lead 20, 22 is curved or folded such that the connecting portion 21 thereof is oriented substantially perpendicular to the plane of the electrode stack 12 such that it can be positioned against the associated bus strap 24, 26. Once positioned, the connecting portion 21 of each end lead is welded to the associated bus strap at welds 30 using weld tool 32 and anvil 34.

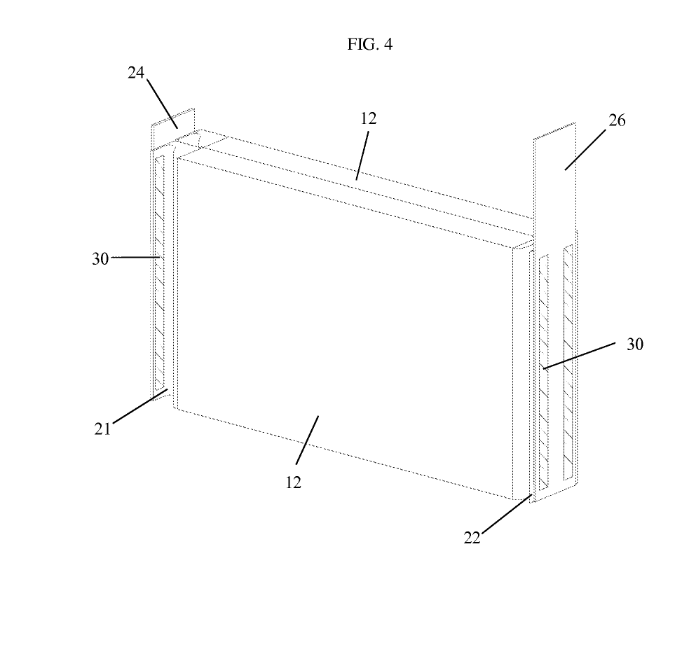

As shown in FIG. 3, the weld 30 is preferably positionally aligned with the lateral end 36 of the electrode stack. That is, the weld is provided in a space x between lines A and B extending from the front and rear sides of the electrode stack 12. As a result, a plurality of electrode stacks 12 can be provided which are adjacent and substantially parallel to each other as shown in FIG. 4. That is, FIG. 4 illustrates two electrode stacks 12 arranged side-by-side and joined to common positive and negative bus straps 24, 26. The end leads 20 of the positive electrode plates 14 are joined to the positive bus strap 24 and the end leads 22 of the negative electrode plates 16 are joined to the negative bus strap 26. Of course, it should be understood that additional electrode stacks could be provided depending on the design criteria of the electrochemical cell.

FIG. 5 shows the two electrode stacks 12 and associated positive and negative bus straps 24, 26 being inserted into a case 32, with a cover 34.

The present invention is an improvement over the prior art in the following respects. For example, the design is simple and efficient allowing multiple electrode stacks to be electrically connected to each other with minimal manufacturing steps and minimal space. In addition, the non-active area of each electrode plate (i.e., the end leads) is minimized to thereby maximize the electrical efficiency of the cell. Other advantages of the invention would be apparent to a person of ordinary skill in the art.

The following is a description of a method of manufacturing an electrochemical cell according to the present invention.

Having obtained the prismatic electrode stack described above, a positive bus strap 24 is positioned adjacent the side edge portion of the positive electrode plate 14 and a negative bus strap 26 is positioned adjacent to the side edge portion of the negative electrode plate 16 at an orientation such that the bus straps are perpendicular to the prismatic plane.

Then, the end lead 20 of the positive electrode plate 14 is folded or curved such that a connecting portion 21 thereof is positioned parallel to and against the positive bus strap 24 and the end lead 22 of the negative electrode plate 16 is similarly folded or curved such that a connecting portion 21 thereof is positioned parallel to against the negative bus strap 26. Thereafter, the connecting portion 21 of the end lead 20 of the positive electrode plate 14 is joined or welded to the positive bus strap 24 and the connecting portion 21 of the end lead 22 of the negative electrode plate 16 is joined or welded to the negative bus strap 26.

Thereafter, the assembly, including the prismatic electrode stack and the positive and negative bus straps 24, 26, is inserted into a case. If additional electrode stacks are desired, they can be arranged parallel to each other and joined to the positive and negative bus straps in a similar manner and positioned in the case.

Although the inventive concept has been described above with respect to the various embodiments, it is noted that there can be a variety of permutations and modifications of the described features by those who are familiar with this field, without departing from the technical ideas and scope of the features, which shall be defined by the appended claims.

Further, while this specification contains many features, the features should not be construed as limitations on the scope of the disclosure or the appended claims. Certain features described in the context of separate embodiments can also be implemented in combination. Conversely, various features described in the context of a single embodiment can also be implemented in multiple embodiments separately or in any suitable sub-combination.

What is claimed is:

1. An electrochemical cell, comprising:
a prismatic electrode stack extending in a prismatic plane and having a plurality of positive electrode plates and a plurality of negative electrode plates stacked alternately with intervening separators therebetween, the positive electrode plates and the negative electrode plates being laterally offset so that end leads of the positive electrode plates extend from one side of the electrode stack and end leads of the negative electrode plates extend from an opposite side of the electrode stack;
a positive bus strap joined to the end leads of the positive electrode plates and a negative bus strap joined to the end leads of the negative electrode plates, wherein said positive and negative bus straps and connecting portions of said end leads of the positive and negative electrode plates are disposed parallel to each other and perpendicular to the prismatic plane of the prismatic electrode stack, whereby said end leads of the positive electrode plates are joined to said positive bus strap at said connecting portions and said end leads of the negative electrode plates are joined to the negative bus strap at said connecting portions; and
a case accommodating the prismatic electrode stack, the bus straps and liquid electrolyte.

2. The electrochemical cell of claim 1, wherein the positive and negative bus straps are joined to the respective side edges of the positive and negative electrode plates by welds.

3. The electrochemical cell of claim 2, wherein said end leads of the positive and negative electrode plates include bare foil edges that are curved 90 degrees.

4. The electrochemical cell of claim 3, wherein the welds are positionally aligned with the lateral ends of the electrode stack.

5. The electrochemical cell of claim 4, comprising a plurality of said prismatic electrode stacks arranged such that the prismatic planes related thereto are parallel to each other.

6. The electrochemical cell of claim 5, wherein for each of said plurality of prismatic electrode stacks, said end leads of the positive and negative electrode plates are respectively welded to the positive and negative bus straps.

7. The electrochemical cell of claim 6, wherein connecting portions of said end leads of each of the plurality of prismatic electrode stacks are perpendicular to said prismatic plane.

8. The electrochemical cell of claim 1, comprising a plurality of said prismatic electrode stacks arranged such that the prismatic planes related thereto are parallel to each other.

9. The electrochemical cell of claim 8, wherein for each of said plurality of prismatic electrode stacks, said end leads of the positive and negative electrode plates are respectively joined to the positive and negative bus straps.

10. The electrochemical cell of claim 9, wherein connecting portions of said end leads of each of the plurality of prismatic electrode stacks are perpendicular to said prismatic plane of each said prismatic stacks.

11. A method of manufacturing an electrochemical cell, comprising:
(a) providing a prismatic electrode stack, said prismatic electrode stack extending in a prismatic plane and having a plurality of positive electrode plates and a plurality of negative electrode plates stacked alternately with intervening separators therebetween, the positive electrode plates and the negative electrode plates being laterally offset so that end leads of the positive electrode plates extend from one side of the electrode stack and end leads of the negative electrode plates extend from an opposite side of the electrode stack;
(b) providing a positive bus strap adjacent the end leads of the positive electrode plates and a negative bus strap adjacent to the end leads of the negative electrode plates at an orientation such that the bus straps are perpendicular to the prismatic plane;
(c) positioning the end leads of the positive electrode plates such that connecting portions thereof are parallel to and against the positive bus strap and positioning the end leads of the negative electrode plates such that connecting portions thereof are parallel to against the negative bus strap;
(d) joining the connecting portions of the positive electrode plates to the positive bus strap and the connecting portions of the negative electrode plates to the negative bus strap; and
(e) inserting the prismatic electrode stack and the positive and negative bus straps in a case.

12. The method of claim 11, wherein said joining step comprises welding.

13. The method of claim 12, further comprising providing another prismatic electrode stack adjacent the prismatic electrode stack and repeating steps (b)-(d) for the another prismatic electrode stack.
